(19) United States
(12) Patent Application Publication
(10) Pub. No.: US 2026/0072902 A1
(43) Pub. Date: Mar. 12, 2026

(54) GENERATIVE AI ASSISTED NATURAL LANGUAGE PROCESSING FOR INTERACTIVE DATA INQUIRY EXPERIENCE WITH OPERATIONAL AND STATISTICAL ENTERPRISE DATA

(71) Applicant: Oracle International Corporation, Redwood Shores, CA (US)

(72) Inventors: Bibin Mathew, Kerala (IN); Kavin Kumar Kuppusamy, Redwood City, CA (US); Diana Samuel, Kerala (IN); Sunil Chawla, Redwood City, CA (US); Sundarraman Narayanan, Redwood City, CA (US); Venkata Krishna Kondepudi, Pleasanton, CA (US)

(73) Assignee: Oracle International Corporation, Redwood Shores, CA (US)

(21) Appl. No.: 19/184,863

(22) Filed: Apr. 21, 2025

Related U.S. Application Data
(60) Provisional application No. 63/691,591, filed on Sep. 6, 2024.

(51) Int. Cl. G06F 16/242; G06F 16/248; G06F 21/62; H04L 9/40

(52) U.S. Cl. CPC G06F 16/243; G06F 16/248; G06F 21/6227; H04L 63/105

(57) ABSTRACT

Systems, methods, and computer-readable media provide a context-specific prompt to answer a user query. The systems, methods, and computer-readable media determine a context based on content of a natural language request and/or determine a role of a user who submitted the natural language request. Additionally or alternatively, templates or RAG sources that will be used for prompt generation may include financials domain-specific knowledge or other domain-specific knowledge or insights. Inclusion of this additional information in the prompt enhances the context to promote more accurate results from a large language model. In one embodiment, the prompt templates are created from various RAG sources, such as payables, general ledger, receivables, and asset management, containing structured data and information specific to the financial domain, enterprise, or other domain, which helps craft accurate prompts. A prompt is generated that identifies a subset of available fields and other selected information based on the role or other context. The prompt template may contain domain-specific knowledge uses a relevant domain or enterprise information to drive relevant results, and an executable query is generated by a large language model based on the prompt. The executable query causes data to be retrieved from a database to generate a result, and information is displayed based at least in part on the result.

### CROSS REFERENCE TO RELATED APPLICATIONS

This application claims the benefit of U.S. Provisional Patent Application No. 63/691,591, filed on Sep. 6, 2024. The entire disclosure of the aforementioned application is incorporated by reference herein in its entirety for all purposes.

### BACKGROUND

Applications provide user interfaces that allow users to navigate sub-interfaces to view, select, or modify different aspects of datasets. Navigating an application to accomplish a task that uses a dataset may require multiple different interfaces that are traversed with menu clicks, item selections, and thorough analysis.

Applications make this process easier by providing shortcuts for frequently used actions. Shortcuts are limited to a discrete amount of functionality given the limited screen space, and many interfaces support interaction with virtually unlimited variations of data via a hierarchy of menu and tool selections. Most users are not even aware of the full depth of most application menu hierarchies and tools. Application developers currently choose between deep, rich functionality at the cost of efficiency and difficulty of use, and flat, efficient shortcuts at the cost of limiting functionality.

### BRIEF SUMMARY

In some embodiments, a computer-implemented method provides a context-specific prompt to answer a user query. The computer-implemented method includes determining a context based on content of a natural language request, augmenting the context using financials, enterprise resource planning (ERP), or other domain specific knowledge leveraging template-based prompt generation to provide insights and/or determining a role of a user who submitted the natural language request. One example feature is that the prompt templates may be created from various Retrieval Augmented Generation (RAG) sources like as payables, general ledger, receivables, asset management etc., which may contain structured data specific to the financial domain. The structured domain-specific data helps craft prompts that produce more efficient and accurate results. Also, the computer-implemented method may be performed using intelligent drivers that analyze user text in real-time, identifying relevant RAG sources based on context and content.

In one embodiment, a prompt is generated that identifies a subset of available fields based on the role and/or other context, and a prompt template such as one that contains domain-specific knowledge. The domain-specific knowledge uses relevant domain or enterprise information to drive generative artificial intelligence, and an executable query is generated by a large language model based on the prompt. The executable query causes data to be retrieved from a database to generate a result, and information is displayed based at least in part on the result.

In one embodiment, a computer-implemented method includes determining that a particular user is authenticated to an application session, and determining a particular role of the particular user. The computer-implemented method further includes accessing a natural language request from the particular user. The computer-implemented method further includes selecting, from a plurality of fields available, a subset of fields that are associated with the particular role and that are determined to be relevant to the natural language request. The computer-implemented method further includes generating a prompt that identifies the subset of fields, and requests a command executable to answer the natural language request. The computer-implemented method further includes prompting a large language model to generate a resulting command, and causing execution of an executable command based at least in part on the resulting command. The executable command causes data to be retrieved to generate a result set. The computer-implemented method further includes causing display of a response to the natural language request based at least in part on the result set.

In a further embodiment, generating the prompt includes determining, for inclusion in the prompt, domain-specific content relevant to the natural language request. The determining is based at least in part on a particular vector embedding of the natural language request, one or more vector embeddings of the domain-specific content, and one or more distances between the particular vector embedding and the one or more vector embeddings.

In the same or a different further embodiment, generating the prompt includes determining, for inclusion in the prompt, one or more example pairings of LLM input and output relevant to the natural language request. The determining is based at least in part on a particular vector embedding of the natural language request, one or more vector embeddings of the one or more example pairings, and one or more distances between the particular vector embedding and the one or more vector embeddings.

In the same or a different further embodiment, selecting the subset of fields that are associated with the particular role and that are determined to be relevant to the natural language request includes selecting, for inclusion in the prompt, one or more fields relevant to the natural language request based at least in part on a particular vector embedding of the natural language request, one or more vector embeddings of the one or more fields, and one or more distances between the particular vector embedding and the one or more vector embeddings.

In the same or a different further embodiment, generating the prompt includes determining, for inclusion in the prompt, one or more values of contextual information from a user session in which the natural language request was submitted.

In the same or a different embodiment, generating the prompt includes determining a particular level of aggregation to recommend for the particular user based at least in part on the particular role. The prompt requests a command executable to answer the natural language request at least in part by applying the particular level of aggregation.

In the same or a different embodiment, accessing, selecting, generating, and prompting are performed by a plurality of different agents supporting the natural language request. The computer-implemented method further includes receiving a plurality of partial results from the plurality of different agents, and assembling the plurality of results to determine the response to the natural language request.

In the same or a different embodiment, generating the prompt identifies one or more commands of an application programming interface. In this embodiment, causing execution of the executable command based at least in part on the resulting command includes invoking the application programming interface with the executable command.

In the same or a different embodiment, generating the prompt identifies one or more workflows, one or more functional descriptions of the one or more workflows, and one or more triggers of the one or more workflows that are based on values of one or more fields. In this embodiment, causing execution of the executable command based at least in part on the resulting command includes updating data of the one or more fields to satisfy the one or more triggers of the one or more workflows.

In the same or a different embodiment, the subset of fields comprises one or more first fields that are frequently used by users having the particular role and one or more second fields that are infrequently used by users having the particular role. In this embodiment, generating the prompt identifies the one or more first fields as frequently used and the one or more second fields as infrequently used.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that provides a context-specific prompt to answer a user query.

FIG. 2 illustrates a system diagram showing an example system for providing a context-specific prompt to answer a user query.

FIG. 3 illustrates a diagram of an example user interface for submitting a natural language request to trigger a context-specific prompt to a large language model for retrieving data from a database to accomplish a task in an application.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

Systems, methods, and computer-readable media are provided for identifying a subset of information for inclusion in a prompt to retrieve data in response to a natural language request based on the role of the user or the context of the request. A description of a resource management system providing a context-specific prompt to answer a user query is provided in the following sections:
PROCESSING NATURAL LANGUAGE QUERIES WITH A LARGE LANGUAGE MODEL
PROMPTS USING SCHEMA SELECTION BASED ON USER ROLE INFORMATION
PROMPTS USING SCHEMA SELECTION BASED ON NATURAL LANGUAGE QUERY CONTEXT
EXAMPLE DOMAIN-SPECIFIC KNOWLEDGE PASSED IN PROMPTS TO THE LARGE LANGUAGE MODEL
INCLUDING EXAMPLE INFORMATION ABOUT A FUNCTIONAL ENVIRONMENT OR PROCESS, SUCH AS AVAILABLE REST API COMMANDS OR FUNCTIONAL WORKFLOWS, IN PROMPTS TO THE LARGE LANGUAGE MODEL PROCESSING RESULTS OF CONTEXTUAL PROMPTS TO LARGE LANGUAGE MODEL
AI AGENT-BASED ARCHITECTURE FOR EVALUATING QUERIES AGAINST MULTIDIMENSIONAL DATA USING SUPPLEMENTAL CONTENT
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Various embodiments described herein enable enterprise application users to query business transactions using natural language by leveraging a large language model (LLM) trained specifically on domain-related knowledge, such as knowledge of data structures and schemas relating to enterprise resource planning. The system also utilizes the domain or enterprise specific knowledge to augment the knowledge of LLM to provide more detailed and accurate answers. The enterprise specialized information is structured in prompt template that includes specific details about the product/domain/enterprise and used to generate accurate and right prompts. Information supplied via prompt template will help the LLM model understand the context further and generate relevant and accurate prompts. This approach equips the LLM with an understanding of domain-specific structures and constructs, such as business units, suppliers, legal entities, ledgers, and/or other information, allowing the system to interpret user queries accurately within the domain-specific context. The generative AI of the domain-aware LLM model may additionally or alternatively automatically derive user context such as job roles and privileges, currency, calendar, etc., and apply them to application query statements along with an appropriate data security context to retrieve accurate data real time and render results in visualization formats of a user's choice.

In one example, a car manufacturer may buy engines or parts from a supplier. The invoice may be sent to the car manufacturer and saved in a system of the car manufacturer to be paid at a later time. The invoice is stored as metadata to a set of liabilities of the car manufacturer.

A user of a resource management system may analyze the stored data and metadata to determine what happened to payments of invoices involving certain entities, or to analyze other activities reflected in the stored data. The resource management system may provide an interface for searching for certain objects, entities, and/or activities based on input provided by a user, and the resource management may display results of top matching objects, entities, and/or activities potentially relevant to the input.

In one embodiment, rather than searching for objects, entities, and/or activities related to a problem, question, or other issue, and then analyzing the objects, entities, and/or activities to resolve the issue, the resource management system may provide a natural language or text input region that accepts a natural language question or other query from the user and maps the natural language query to a schema available to answer the natural language query. A large language model is prompted with information about the schema as well as domain specific knowledge or specialized knowledge such as how the invoices are managed, how invoices are stored in database and such leveraging prompt templates, and the large language model provides results or a structure or object to use for obtaining the results that are used to cause display of information that answers the natural language query. In this manner, the resource management system supports more direct, seamless, and efficient handling of queries to facilitate a more efficient troubleshooting of issues.

In one example, a user may submit a natural language query, “what are the invoices for Supplier A?” In response to the query, the LLM may return a command that retrieves the invoices for Supplier A and a user-designated (per query) or user-specified default (across many queries) format or visualization to use for displaying the results. In a further example, the user may submit a natural language continuation of the natural language query, “why are they not paid?” In response to the natural language continuation, the LLM may be informed, via a prompt, of the context of what objects the user is analyzing via a user interface in a user session and/or what objects or values have recently been returned or displayed to the user in the user session or in past user sessions. The additional context may be enhanced by including financials/ERP domain-specific understanding using templates for prompt generation. The additional context may be used by the LLM to provide a response that is targeted to the appropriate context that was provided in the prompt.

A Retrieval Augmented Generation (RAG) architecture is used to combine information retrieval with text generation. The LLM may be tuned with domain knowledge and made capable of responding to domain-specific queries. During processing, there are different RAG layers to inject domain-specific knowledge to the LLM through prompts, prompt templates, prompt sections, and/or parameters of prompt templates. The RAG layers may inject different knowledge for payables, receivables, general ledger, financial common, and other domain-specific knowledge bases. From the user context and usage pattern, the resource management system identifies the most applicable data with which to generate the prompt. From the financials domain knowledge included in the prompt templates, the system can generate a prompt for financials data using the RAG sources. Such data may be financials or other domain-specific information for certain prompt templates, inserted in specific placeholders in corresponding prompt template(s) or various prompt templates, and/or added to sections of certain or various prompt templates. The placeholders or sections may be delimited from a remainder of the prompt template via special or designated characters or syntax, and/or identify a name of a variable to be substituted such that variables may be efficiently located and substituted into corresponding positions of the prompt templates as a prompt is generated using production data. Retrieval of similar or otherwise relevant data may be done from a replica database for improved performance and scalability over retrieval from a production transactional database. In one embodiment, the prompt generation and enrichment architecture operates on top of an application platform object using a Rest API layer and does not rely on Structured Query Language (SQL) queries. For example, the data may be accessible via a BOSS database abstraction layer for querying and updating underlying database structures without using the database-side object identifiers of the underlying database structures.

RAG operates to transform a user query into a vector embedding of the user query and uses the vector embedding of the user query to query a vector database, which retrieves information relevant to that question's context. That contextual information plus the original prompt are then fed into the LLM, which generates a text response based on the generalized knowledge of the LLM and the timely, specific, and potentially private or proprietary contextual information. While the process of training the generalized LLM is time-consuming and costly, new data can be loaded into the embedded language model supported by RAG and translated into vectors on a continuous, incremental basis. Similarity of an input user query may be determined by the vector database using cosine similarity and/or any other vector distance algorithm. RAG uses semantic search, which goes beyond keyword search in generating vector embeddings for comparison by determining the meaning of questions and source documents and using that meaning to retrieve the most similar results. By using the vector database, the generative AI can provide the specific source of private or proprietary data cited in the answer.

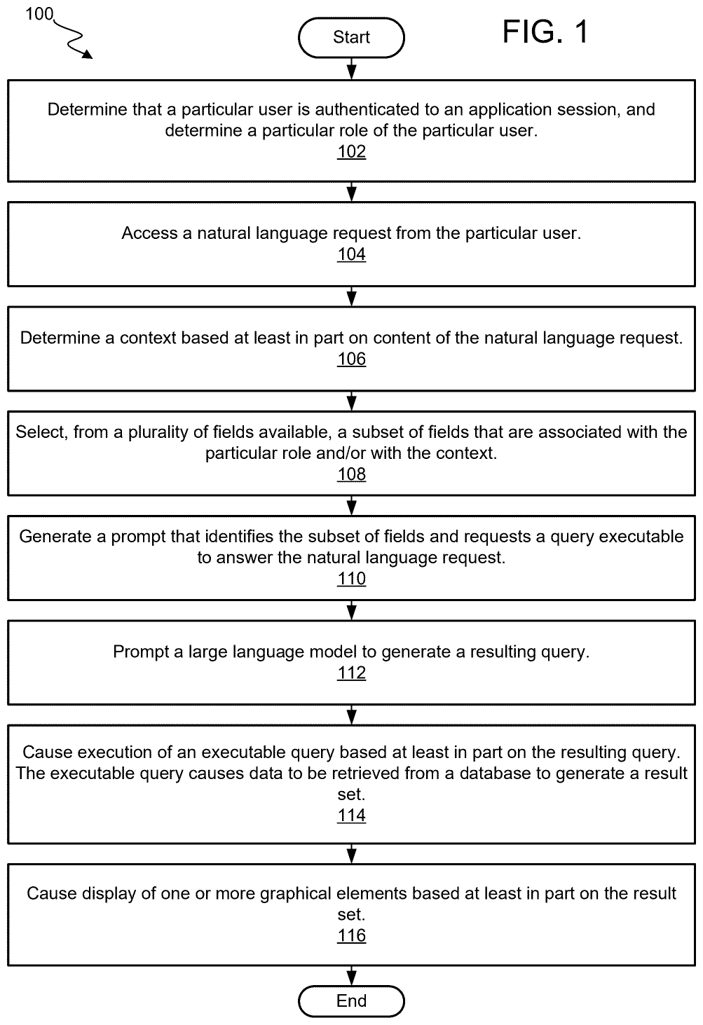

FIG. 1 illustrates a flow chart of an example process 100 that provides a context-specific prompt to answer a user query. In block 102, a computer system determines that a particular user is authenticated to an application session, and the computer system further determines a particular role of the particular user. In block 104, the computer system accesses a natural language request from the particular user. In block 106, the computer system determines a context based at least in part on content of the natural language request. In block 108, the computer system selects, from a plurality of fields available, a subset of fields that are associated with the particular role and/or with the context. In block 110, the computer system generates a prompt that identifies the subset of fields and requests a query executable to answer the natural language request. In block 112, the computer system prompts a large language model to generate a resulting query. In block 114, the computer system causes execution of an executable query based at least in part on the resulting query. The executable query causes data to be retrieved from a database to generate a result set. In block 116, the computer system causes display of one or more graphical elements based at least in part on the result set.

In various embodiments, contextual information such as field(s), example LLM input(s), example LLM output(s), example pairing(s) of LLM input and output, user session information, and/or example domain-specific knowledge are selected for inclusion in a prompt to a large language model based on which items of such contextual information are determined to be relevant to a user query, for example, using cosine similarity or as determine from a RAG data source. The contextual information may be selected based on items of contextual information that are associated with the particular role at least in part by selecting one or more contextual items as relevant to the natural language request based at least in part on a particular vector embedding of the natural language request, one or more vector embeddings of the one or more contextual items, and one or more distances between the particular vector embedding and the one or more contextual items.

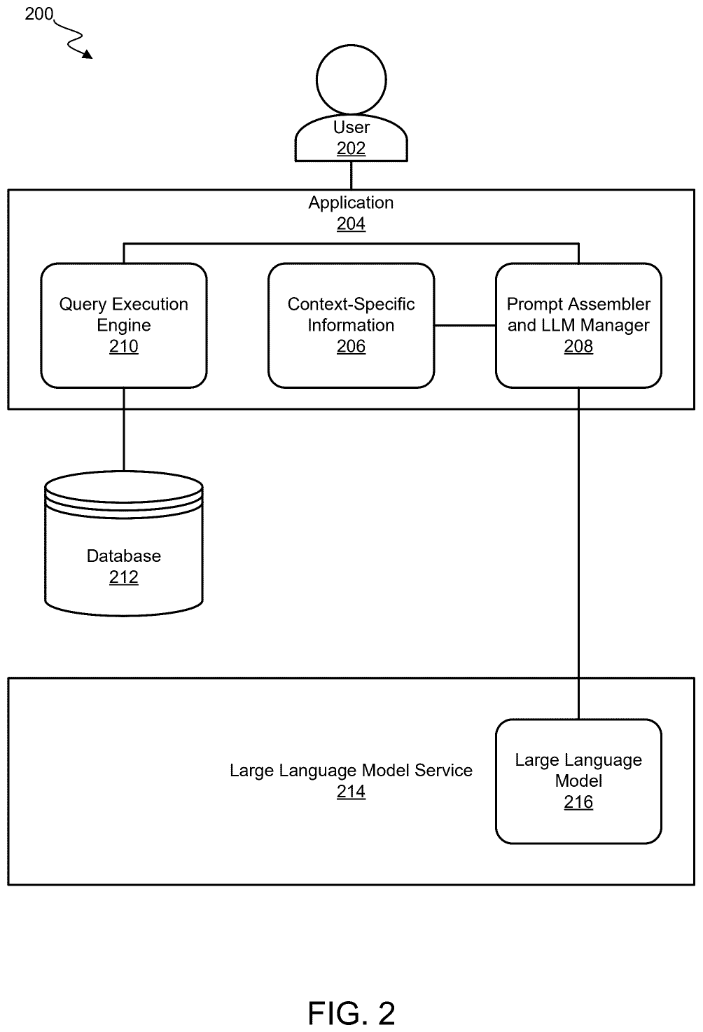

FIG. 2 illustrates a system diagram showing an example system for providing a context-specific prompt to answer a user query. As shown, user 202 submits a natural language request to application 204. Application 204 uses prompt assembler and LLM manager 208 to select context-specific information 206 to be included in a prompt. Prompt assembler and LLM manager 208 then prompts large language model 216 of large language model service 214. A result is received from the large language model 216 by application 204, which causes execution by a query execution engine 210 of an executable query determined from the result (e.g., constructed based on the result or extracted from the result). The executable query accesses database 212 to retrieve results that are displayed on a user interface of application 204.

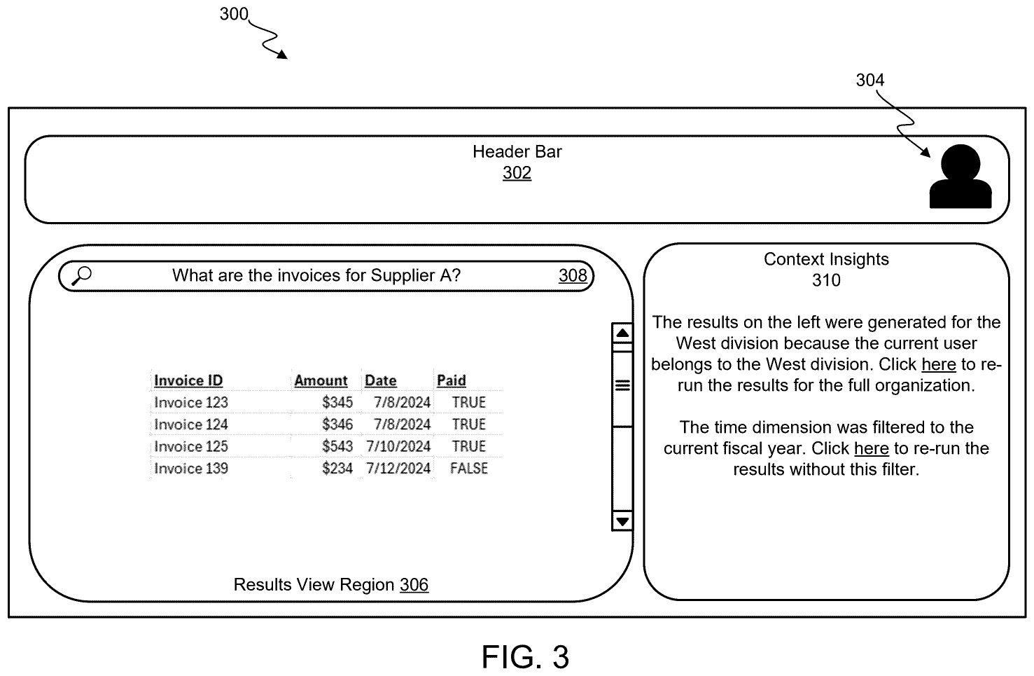

FIG. 3 illustrates a diagram of an example user interface 300 for submitting a natural language request to trigger a context-specific prompt to a large language model for retrieving data from a database to accomplish a task in an application. As shown, user interface 300 includes a header bar 302 that identifies a user scope of an application session with the application. The user scope is indicated by graphical user indicator 304, which indicates which user is logged into the application session. The user interface includes a text input region 308 for submitting natural language queries to the application. As shown, the query, “What are the invoices for Supplier A?” has been received, and invoice IDs, amounts, dates, and paid columns are shown in results view region 306. Context insights region 310 includes information about how the results were generated and options to regenerate the results using different options. For example, the first detail indicates “The results on the left were generated for the West division because the current user belongs to the West division. Click here to re-run the results for the full organization.” Upon selection, the link would change the stated assumption made when prompting the large language model to assume a global organizational context rather than a context specific to the organization of the user. The second detail indicates “The time dimension was filtered to the current fiscal year. Click here to re-run the results without this filter.” Upon selection, the link would change the stated assumption made when prompting the large language model to assume a global time context rather than a context specific to the application session.

### Processing Natural Language Queries With a Large Language Model

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. In various other examples, default credentials may be used by the query processing service. In one embodiment, the credentials include user-specific credentials/roles, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may specify tree(s), structure(s) or pathway(s) of data that are accessible to a user, and/or may include metadata about different nodes in the tree(s), structure(s), or pathway(s) about how frequently same or similar users or users with same or similar roles as a current user access data for the different nodes. The data schema may be formatted in a hierarchical format, such as JSON, XML, or another structured and delimited format that distinguishes between members at different levels of the hierarchy.

The prompts may also specify a format for providing the reply, through examples and/or through explicit description of the requested format. The examples may be selected as examples that are most relevant to a user query, for example, by selecting the examples that have a highest level of similarity (e.g. cosine similarity) to the user query. The examples may include examples of user inputs and/or outputs that are valid and/or invalid, labeled as such. In various example prompts, the valid input examples may be mapped to valid output examples to allow the LLM to consume the examples inputs and outputs and generate a new conforming output based on an input that does not exist verbatim among the example inputs. In some embodiments, the examples are further filtered based on which examples are relevant to a domain of the user query and/or which examples operate on data accessible to a user role of the user submitting the user query. In this manner, the LLM is provided with example inputs and outputs from within accessible domains for a given user query and about similar topics as covered by the given user query. For example, some topics may be accessible via certain application interfaces, and other topics may be accessible via other application interfaces. The prompt may include examples that retrieve information accessible via the application interface displayed when the user query was received or applicable to other context of the user session such that the results are applicable to the user interface or other context from which the user query was submitted.

In one example, a user query may state “show me my uncleared payments”. In this example, the database may not include a payment status of “uncleared,” but instead multiple join operations may be performed against a schema to determine a set of payments having statuses that are uncleared. In order to generate and execute this query, a prompt may be generated to include, based on a RAG source of domain-specific knowledge, a definition of “uncleared” or similar terminology, as well as column definitions, based on a RAG source for schema information, for a plurality of columns of data, such as data having column names similar to “payments” or “uncleared.” This supplemental information may be brought into the prompt as sets of data specific to different types of use cases, such as a set that include multiple related definitions and/or definitions relevant to examples that were similar to the user query, and/or as individual definitions or pieces of information. Pulling in larger sets of data with related definitions may provide the LLM with a more comprehensive understanding of the domain space with less risk of misinterpreting an individual definition. The LLM may consume the prompt, schema, and corresponding definitions to return a database query or API command to be executed against a service that uses the schema, and the service may return a result for inclusion in a response to the user query such that the result includes a set of uncleared payments for the user who submitted the user query.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{“and”}” or “[“and”]” in the response. The consumable JSON object may be separated from a remainder of the response for consumption by the application to create an executable structure to trigger application functionality.

### Prompts Using Schema Selection Based on User Role Information

In one embodiment, user role information and/or expressed or non-expressed user preference information is provided in the prompt to guide the LLM to produce results tailored to the user. For example, a machine learning model may track historical information about users with different roles and determine that users having one role often view certain types of data, results, or interfaces, and users with other roles often view other types of data, results, or interfaces. Based on the user role information, the resource management system may generate a prompt to the LLM that indicates the user has a particular role and/or historical preferences or expressed preferences that are associated with the particular role or the particular user. For example, users with different roles may prefer to view certain types of data or certain views of data, such as a fine-grained view focused on specific business units (such as those managed by the user) or a summarized or aggregated view (such as for users that manage many business units or serve as an administrator), or certain time periods of data such as current working data or historical data.

In one example, the prompt may include the following information:

Access to data variables based on the user's role:
Financial Administrator: Requires summarized data, such as total outstanding invoices by month.
Payables Manager: Needs detailed information, including individual invoice terms and due dates.

As another example, whether or not the user role information is directly included in the prompt, the prompt may include different data structure names, definitions, and available REST API command(s) and their specifications depending on functionality relevant to the user role of the user who submitted the user request. These different data structure names and definitions may guide the functionality provided to different users even if the LLM is not aware that such functionality is being guided by selective placement of the data structure names and definitions and command specifications.

In various embodiments, the role of the user may be used to filter, constrain, or select which fields, corresponding values, or other information is presented in the prompt. For example, prompt templates may be selected according to the corresponding user roles, and, even within the selected prompt template, selected fields may be customized based on various roles of varying users executing queries that use the selected prompt template.

In one embodiment, even if a set of data is available to a users of a particular role, users of the particular role might not normally query that set of data and may instead more frequently query another set of data. In these embodiments, additional information may be passed in the prompt to indicate subsets of the schema available to the user that are frequently queried by users having a particular role that matches the user's role, subsets of the schema available to the user that are not as frequently queried by users having the particular role, and/or subsets of the schema available to the user that are rarely queried by users having the particular role. By providing query frequency information with the schema information, the large language model may be instructed to provide results along high frequency pathways using data frequently accessed by same or similar users or users with same or similar roles before exploring results along lower frequency pathways infrequently accessed by same or similar users or users with same or similar roles.

In one embodiment, a schema of accessible data structures for a user role corresponding to a user of a given session is passed to the LLM in the prompt without passing in examples, schema information, or other information specific to other data structures that are not accessible to the user role. For the schema that is accessible, additional metadata may be provided to indicate a frequency of access. In one example, a manager may have access to a first set of data structures, and a salesperson may have access to a second set of data structures that does not include at least some of the first set of data structures. For example, the second set of data structures may be specific to the business units of the salesperson and may exclude data specific to business units of other salespeople even though data about those other business units is accessible to the manager. In this example, a prompt generated in support of the manager's query may include schema information about data for a plurality of business units, and the LLM may generate a result that causes display of information or triggers other operations relevant to the plurality of business units. In contrast, a prompt generated in support of the salesperson's query may include schema information about data for one or a few select business units, and the LLM may generate a result that causes display of information or triggers other operations relevant to the one or few select business units.

In one embodiment, different roles have different metadata stored in association with the roles, the metadata indicating how high a level users of that role prefer by default in reports. For example, manager roles may have metadata stored in association with them to indicate that users having the manager roles often prefer, or by default prefer, to see aggregate data, or data aggregated on business unit, division, or another dimension or metric. Salesperson roles may have metadata stored in association with them to indicate that users having the salesperson roles may often prefer, or by default prefer, to see data specific to the salesperson's individual performance. Such metadata may be included in the prompt to reduce a burden on the LLM to make inferences about how high a level the user wants to see results and/or how to group or aggregate results.

### Prompts Using Schema Selection Based on Natural Language Query Context

In one embodiment, information is provided to enable a large language model to generate an application query or a structured query language (SQL) query or other query to obtain information to answer a query, based on a listing of schema information available for obtaining data to support the answer.

In one example, the information provided to the large language model in the prompt is based on the user interface being viewed by the user when the query is submitted, based on objects or data being viewed or accessed by the user, based on activity in the user session with the application, or based on information about a user's past activity in user sessions to guide the large language model in generating a response for the user.

Current default views, objects, and other metadata about the user session may also be included in the prompt as contextual information to guide the LLM to generate a result that is more applicable to the user's intent of the user request. For example, default business units, ledgers, or other information most frequently accessed by a user may be passed in as default in case the user request refers to an object without naming which object is intended to be accessed or used.

In one embodiment, the prompt includes information about whether the user session is being accessed on a mobile device, a tablet, or a laptop and a form factor associated with the corresponding device. The response may account for how much screen real estate is available to show results and what result types are paired with what screen sizes or form factors.

The prompt may include instructions to defer to the objects and structures and requested outputs referenced explicitly in the user query and use the default objects and structures and requested outputs only when the user query is not clear about the target.

In various embodiments, when a user role or other context is known and metadata is being added to the prompt based on the user role or other context, such information may include dynamic values such as not just the name of a dimension but the value of a member of the dimension that is particularly associated with the user. For example, a first user may be associated with an East Branch of the organization, and the prompt may be updated for the first user to include not only the “Division” dimension but also that the default value for “Division” is “East” for the first user, unless otherwise specified in the user request. Similarly, a second user may be associated with a West Branch of the organization, and the prompt may be updated for the second user to include not only the “Division” dimension but also that the default value for “Division” is “West” for the second user, unless otherwise specified in the user request.

In one embodiment, the additional context is retrieved from an elastic index, which is a logical namespace that holds objects relevant to the user. The index may be updated as a user requests data in a user session, and the index may be queried when a request is received from the user to determine which dimensions should be named and/or which members should be named for a given user request.

In various embodiments, the context of the user request may be used to filter, constrain, or select which fields, corresponding values, or other information is presented in the prompt. For example, prompt templates may be selected according to the corresponding context, and, even within the selected prompt template, selected fields may be customized based on various roles of varying users executing queries that use the selected prompt template.

### Example Domain-Specific Knowledge Passed in Prompts to the Large Language Model

In various embodiments, domain-specific knowledge may be attached to the user query depending on the domain of inquiry in the user session or by the application component involved in receiving the user query. In various examples, a financial interface component may pass in financial domain-specific knowledge. Other domain-specific components may pass in payables domain-specific knowledge, payables payments domain-specific knowledge, derived values from user input, derived/defaulted values from the user session, financials derived information, payables derived information, and/or BOSS SQL semantics or any other query language semantics for generating a data query to retrieve data in support of an answer to the user query.

In one example, payables domain knowledge includes the following details provided in a custom prompt(s) or prompt template(s) to the LLM for payables-specific questions:

Questions about Payables typically involve entities like Invoices, Suppliers, Holds, Tolerances on top of entities from Financials
Supplier—Alternative names: {Vendor, Payee, Seller, Provider}
Invoice—Alternative names: {Bill, Invoice, Memo, Payables Document}
Tolerance—Alternative names: {Limit, Threshold, Deviation, Variance, Allowance}
Budgetary Control—Alternative names: {Funds check, Payment limits, Payment allowance}
Hold—Alternative names: {Restriction, Constraint, Pre-Condition}

### Invoice Types:

INVOICE_TYPE_LOOKUP_CODE in AP_INVOICES_ALL identifies the invoice type, such as Standard, Credit memo, or Prepayment

### Payables Invoices:

AP_INVOICES_ALL: This table contains records for all payables invoices
ORG_ID column stores the Business Unit
VENDOR_ID column stores the Supplier
VENDOR_SIDE_ID column stores the Supplier Site
TERMS_ID column stores the Chosen Payment Term

### Prepayment:

Available Prepayment Invoices are Payable Invoices whose PREPAY_AMOUNT_REMAINING is not equal to 0
Unapplied Prepayment Balance indicates how much of the prepayment is still available that can be applied to unpaid or partially paid invoices
   PREPAY_AMOUNT_REMAINING in table AP_INVOICE_DISTRIBUTIONS_ALL indicates the amount of prepayment that can still be applied to an invoice. This field will be 0 if no prepayment is left to be applied
   EARLIEST_SETTLEMENT_DATE in AP_INVOICES_ALL indicates the date associated with a prepayment after which it can be applied to invoices. Only used for temporary prepayments. Column is null for permanent prepayments and other invoice types
   INVOICE_INCLUDES_PREPAY_FLAG in AP_INVOICE_DISTRIBUTIONS_ALL indicates whether prepayment amount is included in the invoice amount
A prepayment can be applied only if it is temporary, paid, approved, not cancelled, has no active holds, and has not already been fully applied.
   CANCELLATION_FLAG in AP_INVOICE_DISTRIBUTIONS_ALL should be N
   APPROVAL_STATUS in AP_INVOICES_ALL should be APPROVED
   PAYMENT_STATUS_FLAG in AP_INVOICES_ALL should be Y
   RELEASE_LOOKUP_CODE not null in AP_HOLDS_ALL for that invoice

In another example, financial domain knowledge includes the following details provided in a custom prompt(s) or prompt template(s) to the LLM for finance-specific questions:

Questions about financials typically involve different entities such as Legal Entities, Business Units, Chart of Accounts, Calendar, Currencies, Ledgers, which are used to segregate financial data.
Each key piece entities have alternative representations or aliases. The alternative names or conventions are listed below.
Legal Entity—Alternative names: {Company, Corporation, Enterprise}
Business Unit—Alternative names: {Organization, Operating Unit, Department, Division}
Chart of Account—Alternative names: {Account structures}
Calendar—Alternative names: {Accounting calendar}
Currency—Alternative names: {Base Currency, Functional Currency}
   Related Contexts: {Foreign Currency, Conversion Type, Exchange Rate}
Ledger—Alternative names: {Financial Ledger, Set of Books, Primary Ledger}
Account—Alternative names: {Segments, Company, Natural Account, Product, Department, Sub-Account}
   In financials contexts terms like YoY (Year over Year) etc. are used to compare financial data or performance between the one period and another period to identify trends, growth rates, and changes in metrics on a period basis. Some of the common comparison trends are as follows: etc.

In another example, derived values from user input are included in the prompt(s) or prompt template(s) as dynamic values that may be inserted into the prompt(s) or prompt template(s) based on information retrieved. These include dynamic values passed into the following prompt template section, for example, where bracketed values are dynamically inserted:

The default business unit for the user is [defaultBusinessUnit] and the default currency is [defaultCurrency] and the timezone is [legalEntityTimeZone]
The user has access to the following [businessUnits]
The following context is derived from user input
Business Units: [businessUnitNames or ID]
Suppliers: [supplierNames or ID]
PaymentStatus: [paymentStatuses or codes]

In another example, derived values from a User Session are included in the prompt(s) or prompt template(s) as dynamic values that may be inserted into the prompt(s) or prompt template(s) based on information retrieved. These include dynamic values passed into the following prompt template section, for example, where bracketed values are dynamically inserted:
User's preferred currency: [preferredCurrency]
User's preferred timezone: [preferredTimeZone]
User's preferred number format: [preferredNumberFormat]
User's security roles: [user-security-roles]

In another example, financials-derived information is included in the prompt(s) or prompt template(s) as dynamic values that may be inserted into the prompt(s) or prompt template(s) based on information retrieved.

### Accounting Calendar:

An accounting calendar is a structured schedule that defines the specific time periods or intervals used for financial reporting and accounting purposes within an organization
Alternative names: {Fiscal Year}
Related contexts: {Accounting Periods, Period Status}
   If no target date was provided, use the system date as the target date and identify the accounting period based on the system date from the below information.
   The accounting calendar for the current user is [accountingCalendarName] and the accounting periods and their cut off dates are listed below.
[{periodName: “Jan-24”, startDate: 01/01/2024, endDate: 01/31/2024, periodStatus: “Open”}]
   Map the target dates to accounting periods based on above details.
   If neither a previous accounting period nor a specific date is provided, default to the current open accounting period [defaultOpenAccountingPeriod]

In another example, payables payment domain knowledge includes the following details provided in a custom prompt(s) or prompt template(s) to the LLM for payables payment-specific questions:

Questions about Payments or Disbursements typically involve entities such as a Discounts, Payment Methods, Documents Payable or Invoices, and Bank Accounts on top of Payables and Financial entities
Each key piece of information for a payment may have alternate representations or aliases.
Payment—Alternate names: {Disbursement, Funds delivery, Funding}
Discounts—Alternate names: {Rebates, Credits, or Early Payment Incentives}
Payment Schedules—Alternate names: {Payment Installments}
Payment Methods—Alternate names: {Payment Disbursement Methods}
   Payment Status: <description>
Alternate names: {Paid Status}

### Payment Schedules:

AP_PAYMENT_SCHEDULES_ALL: This table contains information about scheduled payments for an invoice.
   The HOLD_FLAG will be set to ‘Y’ if a hold is placed on the scheduled payment, indicating that the invoice is not ready for payment, and ‘N’ otherwise.

### Payment Status:

PAYMENT_STATUS_FLAG in AP_INVOICES_ALL is the flag that indicates the payment status of an invoice:

### Payments

AP_CHECKS_ALL: This table contains records for all the payables payments.
   Value in PAYMENT_METHOD_CODE column indicates the payment method
   Value in STATUS_LOOKUP_CODE column indicates the status of a payment

In one example, a user request for “Show invoices not ready for payment with discounted payment terms”may trigger the following prompt:

User Input: Show invoices not ready for payment with discounted payment terms
###Derived from User Input###
Questions about Payments or Disbursements typically involve specific entities such as a Supplier, Business Unit, Discounts, Payment Methods, Documents Payable, or Bank Accounts.

### Handling Aliases:

Each key piece of information for a payment may have alternate representations or aliases. The LLM should recognize and account for these variations to ensure accurate responses:
Supplier: This may also be referred to as Vendor, Payee, or Third Party.
Business Unit: This may also be known as Organization, Operating Unit, Department, or Division.
Ledger: The term Ledger should be interpreted as the financial ledger or book of accounts.
Legal Entity: This may also be referred to as Company, Corporation, or Enterprise.
Invoice: Could be mentioned as Bill, Statement, or Payables Document.
Discounts: Can also be referred to as Rebates, Credits, or Early Payment Incentives.
Payment Terms: Includes terms like Net 30, Net 60, Early Payment Discount, or Payment Due Date.
   When processing user queries, the model should map these aliases to their respective entities to maintain consistency and accuracy in the responses.

### ###Defaulted From User Session###

### Handling Currency:

The default reporting currency for this query is [USD]. Ensure that all financial amounts are displayed in [USD] unless the user specifies a different currency.

### User Information Level:

Access to data variables based on the user's role:
Financial Administrator: Requires summarized data, such as total outstanding invoices by month.
Payables Manager: Needs detailed information, including individual invoice terms and due dates.
   ###financials Common Knowledge###

### Fiscal Year:

The fiscal year begins on [April 1]. Ensure that all fiscal year-related queries are aligned with this start date.

### Fiscal Year Mapping:

April 1, 2024-March 31, 2025: ‘FY 2024-2025’
April 1, 2023-March 31, 2024: ‘FY 2023-2024’
April 1, 2022-March 31, 2023: ‘FY 2022-2023’

### Accounting Period:

When processing queries that involve dates, map the specified date or date range to the corresponding accounting period:
January 1-January 31: ‘January 2024’
February 1-February 28/29: ‘February 2024’
March 1- March 31: ‘March 2024’
April 1-April 30: ‘April 2024’
May 1-May 31: ‘May 2024’
June 1-June 30: ‘June 2024’
July 1-July 31: ‘July 2024’

### Default Period:

If neither a previous accounting period nor a specific date is provided, default to the current open accounting period (e.g., ‘August 2024’).

### ###Payables Invoice Knowledge###

### Business Unit:

The default business unit XX (defaulted to the Payables business function for which the user has access).

### Ledger ID:

The default ledger ID is [xx], which corresponds to the default business unit.

### Payables Invoices:

AP_INVOICES_ALL: This table contains records for all payables invoices
Each invoice will have an associated payment term.

### ###PAYABLES PAYMENT KNOWLEDGE###

### Payment Schedules:

AP_PAYMENT_SCHEDULES_ALL: This table contains information about scheduled payments for an invoice
   The HOLD_FLAG column will be set to ‘Y’ if a hold is placed on the scheduled payment, indicating that the invoice is not ready for payment, and ‘N’ otherwise.
   The PAYMENT_STATUS_FLAG column will have the following values:
      ‘Y’ for fully paid payment schedules.
      ‘N’ for unpaid scheduled payments.
      ‘P’ for partially paid scheduled payments.

### Payment Terms:

AP_TERMS_LINES: This table stores information about the payment terms associated with invoices.
   Values in the DISCOUNT_PERCENT and DISCOUNT_DAYS Columns Indicate that a discount is available for early invoice payment.

In various examples, domain knowledge is included in the prompt by adding relevant details that are pulled in based on content of the questions, what interface the user request is coming from, and/or a user's role or typical set of tasks. Such domain knowledge may be identified by creating a vector embedding of the user query and vector embeddings of corresponding supplemental content from within supplemental content accessible from or frequently accessed by users using the interface or users having the role or carrying out the task. A similarity of the vector embeddings of the filtered supplemental content may be determined for the query, for example, based on cosine similarity or any other vector distance metric. In another embodiment, instead of or in addition to filtering supplemental content based on user role and query-originating interface, the supplemental content may be further ranked based on which content is most relevant to the user role or query-originating interface, such as content that is most frequently accessed from users having the user role or users using the query-originating interface. The most similar supplemental content may be attached to or included in the prompt (for example, in location(s) specified by the prompt template for the type of supplemental content), and the prompt may be executed against the large language model.

In various embodiments, the resource management system includes, in the prompt, domain-specific knowledge that extends beyond table names and resource types to include term definitions, interactions or relationships between variables and/or calculations based on variables, data constraints or expectations for default values in different scenarios, and/or any other information not inherent to the LLM or to the schema itself, such as the types of information provided in the examples. This additional domain-specific knowledge improves the quality of the response from the LLM.

### Including Example Information About a Functional Environment or Process, Such as Available Rest API Commands or Functional Workflows, in Prompts to the Large Language Model

The example prompts may also pass in information about a functional environment that is available for processing a result, such as a set of available commands to execute via a query interface and/or functional workflows such as an automated business process that is configured to consume data and perform an operation or transformation using the data. Such commands may include, for example, commands that are accessible via a REST API, as well as descriptions of the commands. Additionally or alternatively, information provided about the functional environment may include a name of an automated or triggered workflow that consumes data as well as a description of the process performed by the workflow, such as fields used as triggers, fields used as outputs, and other variables impacted by the workflow and algorithms used by the workflow. Whether commands are directly executable via a REST API or triggerable via a workflow, the commands to be exposed in each of the prompt templates may be listed along with the functionality of each command and information about how to execute or trigger the command, and different prompt templates may support different subsets of commands that may be output from the large language model. The prompt may also include example usages of the different REST API commands or other commands through providing example user input and example output that conforms to user expectations. The output commands may be returned to the resource management system and executed using the REST API and/or by storing output data in a corresponding trigger field to cause retrieval of data from data structures, to cause changes to data structures, and/or to generate output for display to the user.

Because the resource manager uses, in the prompt templates, instructions for interacting with REST API(s) and/or other commands such as workflows, different customers using the resource manager are able to customize the REST API and/or workflow instructions depending on the REST APIs and/or workflows available to that specific customer. REST API commands and/or workflow triggers, as well as functionality of the commands in the REST APIs and/or workflows may vary from customer to customer for different REST endpoints and/or workflows. For REST API commands, the resource manager may store information about the REST endpoint and any authentication tokens or other connection metadata so the REST API commands received from the LLM may be included in a request to the REST API, using the endpoint and any connection metadata, to execute the commands against the REST API and return results of the execution on an application interface displayed to the user. For workflow triggers, the resource manager may store information about the fields to be modified to trigger the workflow and how to modify the triggering fields so that the instructions received from the LLM to modify the triggering fields may be executed, for example, against a database storing those fields, to trigger corresponding workflow(s) and cause downstream operations to be performed, for example, in an application.

A solution using REST APIs does not require a direct connection to the database, and commands exposed via REST APIs may implement limited or directed functionality against the database so that the functionality supports what is needed in the application but does not allow the user to disrupt application functionality by incidentally or intentionally changing underlying database structures without the guardrails, limitations, and extra security constraints placed on authenticating requests by the REST API and providing limited execution pathways for REST API commands.

Additionally, using REST APIs rather than direct queries to the database enables LLM functionality to customers even if the customer does not have access to a database with LLM functionality available. The REST APIs provide a layer of indirection that allows LLMs to be called outside of the database and called regardless of how the customer's underlying data is stored.

In one embodiment, the REST API uses a BOSS query language that abstracts underlying data structures to offer higher-level access to the data structures using aggregated views accessible via the REST API.

In a particular example, a query “What are the installments which are paid through check and electronic funds?” is converted by the LLM into a BOSS data query: “SELECT* FROM invoiceInstallment_view_payablesPaymentSchedule WHERE paymentMethodCode=‘CHECK’ OR paymentMethodCode=‘EFT’.” In addition to the user query, the prompt to the LLM may provide the REST API model, such as a structure of objects that may be specified in a structured data format such as JSON. The model may specify the invoiceInstallment_view_payablesPaymentSchedule structure and the paymentMethodCode column, for example, among other structure and columns, and the LLM may use this information to generate the data query. The model may include not only different data structures and columns that are available but also example values that are valid for the different data structures and columns.

In various embodiments, rather than passing in the entire model to the prompt, a core portion of the model is passed into the prompt, and portions of the model and model metadata describing those portions is passed into the prompt if the user query matches a category of those portions. For example, the user query may match the category based on a semantic similarity between the user query and the category. For example, a vector embedding of the category may be compared to a vector embedding of the user query to select a category or categories that are most relevant to the user query (e.g., closest cosine similarity) and determine additional metadata to include as the metadata stored for the selected category or categories.

In this example, even though the user request included the conjunctive word “and,” the user request is transformed into a disjunctive query using “OR” because the LLM recognized that check and electronic funds are alternative payment strategies rather than complimentary payment strategies and inferred the intended meaning to be “OR”. If the “OR” was replaced with “AND” in a user-submitted data query, the resource management system may return no results as the literal result of the precise data query. In this scenario, the user may receive results that accomplish the intent even though the intent was phrased incorrectly.

In one example, Oracle Cloud Infrastructure REST APIs use standard HTTP requests and responses. Each may contain headers for pagination, entity tags, and other information. Each response may include a unique request ID in the response header so the requesting entity may associate the response with the corresponding request.

Many REST API operations use JSON in the request body and/or return JSON in the response body. The specific contents of the JSON are described in the API documentation for the individual operation, and these JSON objects may trigger application functionality, creation of or changes to data structures, and/or cause display of data in applications.

In one embodiment, workflows may be triggered using write operations to an underlying database that is configured to store data accessible for triggering workflows. Such operations may be triggered using database commands and/or higher-level application commands that, when executed, interact with the underlying database to cause a workflow to be triggered. In another embodiment, workflows may be triggered using other operations that do not write to a database. For example, an email having a certain format may be triggered to be sent if the workflow is triggered based on an email received having the certain format. In this embodiment, the LLM may be instructed, in the prompt, about the certain format, the email trigger, and how to trigger sending an email from within the application. In another example, an application session may be updated without updating an underlying database, and the workflow may be triggered by an update to the application session. In this example, the LLM may be instructed, in the prompt, about the workflow and how the application session may be updated to trigger the workflow. In various embodiments, any set of data and/or operation may be identified in the prompt to the LLM, along with instructions about how to change the set of data to trigger downstream operations and/or how to execute the operation directly. The LLM may consume such information to return a result that is executable to change the set of data accordingly and/or to execute the operation accordingly.

In one embodiment, an application, platform, or other system consuming the result may validate the result prior to execution, to ensure the command(s) to be triggered are within a set of command(s) available for LLM-based triggering, and to ensure that the change(s) to the set of data and/or operation(s) to be executed are being performed using correct syntax, data type(s), and/or valid parameters.

### Processing Results of Contextual Prompts to Large Language Model

In one embodiment, the LLM provides a response that includes an application query or a structured query language (SQL) query or other query that may be executed to obtain information to answer a query. The response may also indicate what visualization (chart format, pie chart, bar chart, etc.) or result set (table, filtered based on certain values, showing certain columns, etc.) should be provided based on the retrieved data. The resource management system may receive the query in the response and execute the query against a database or other information retrieval system. A result set determined from query execution may then be displayed or used in a user interface to answer the query. The result set may be displayed in the visualization or included in other format or content as specified by the LLM in the response based on the user query.

### AI Agent-Based Architecture for Evaluating Queries Against Multidimensional Data Using Supplemental Content

In various examples, a single agent system receives a query, interacts with an LLM, executes command(s), and/or displays results. In various other examples, a multi-agent system includes different agents for performing different functionality in a pipeline for handling user queries. In one embodiment, a query processing agent or orchestrating agent receives a user query and associates the user query with one or more different worker or inquiry agents that have an affinity or specialty for handling certain query portions or query topics. For example, query or sub-query portions that relate to a first topic may be mapped to a first worker agent, and query or sub-query portions that relate to a second topic may be mapped to a second worker agent. The different agents may be selected based on a history of handling similar topics, and/or based on a hard mapping of certain similar topics to the agent. The different agents may have different preconfigured tools, different processes or sub-steps, different numbers of round trips with the LLM, different prompt templates, different RAG sources, and/or other different characteristics that help the different agents more efficiently or accurately handle queries or sub-query portions that are mapped to the agents.

In some examples, a single query may be mapped to multiple different worker agents, with a first query portion being mapped to a first worker agent and a second query portion mapped to a second worker agent. The different worker agents may use tools, RAG sources, and/or LLM prompts to generate results for the corresponding query portions, and the orchestrating agent may combine the results into a reply to the user query and/or execute operation(s) based on one or both of the result(s) before combining information determined from the execution of the operation(s) to generate a response to the user query. The different worker agents may communicate with each other, independently interact with an LLM, and communicate with the orchestrating agent, which may also independently interact with the LLM to combine results.

In one embodiment, the orchestrator agent interacts with a worker agent to generate a resulting command for execution in a system accessible to the orchestrator agent, and the orchestrator agent also interacts with an insights agent for analyzing a result of execution and identifying anomalies or other insights from the result, for the purpose of highlighting such insights in a reply to the user query. In various embodiments, the insights agent may also be used in a monitoring workflow for monitoring and alerting users of anomalies and/or other insights as data changes, depending on stored user preferences.

### computer system architecture

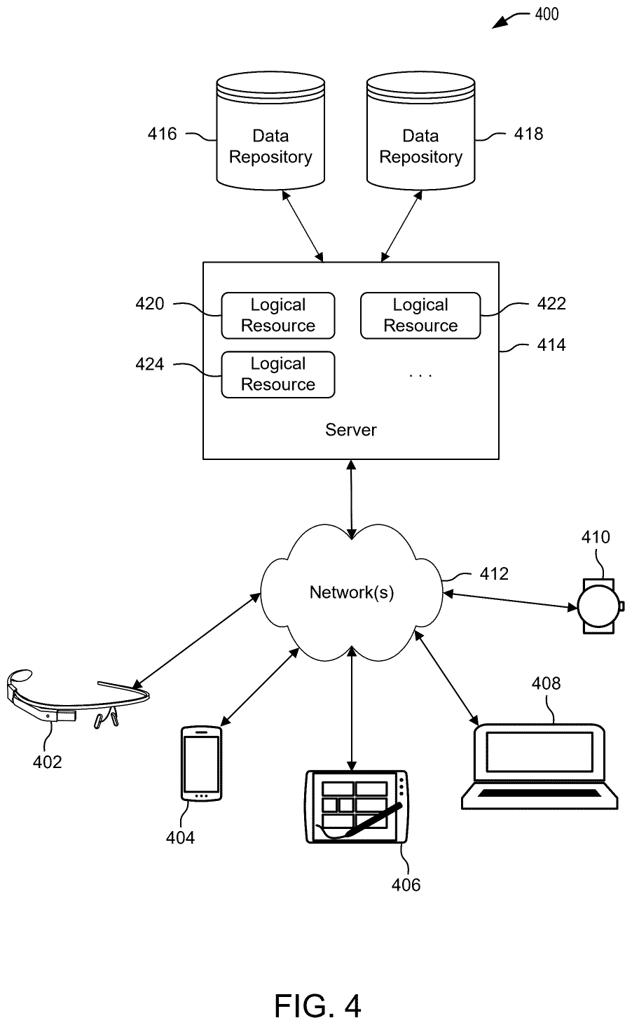

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for providing a context-specific prompt to answer a user query.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for providing a context-specific prompt to answer a user query in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for providing a context-specific prompt to answer a user query. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

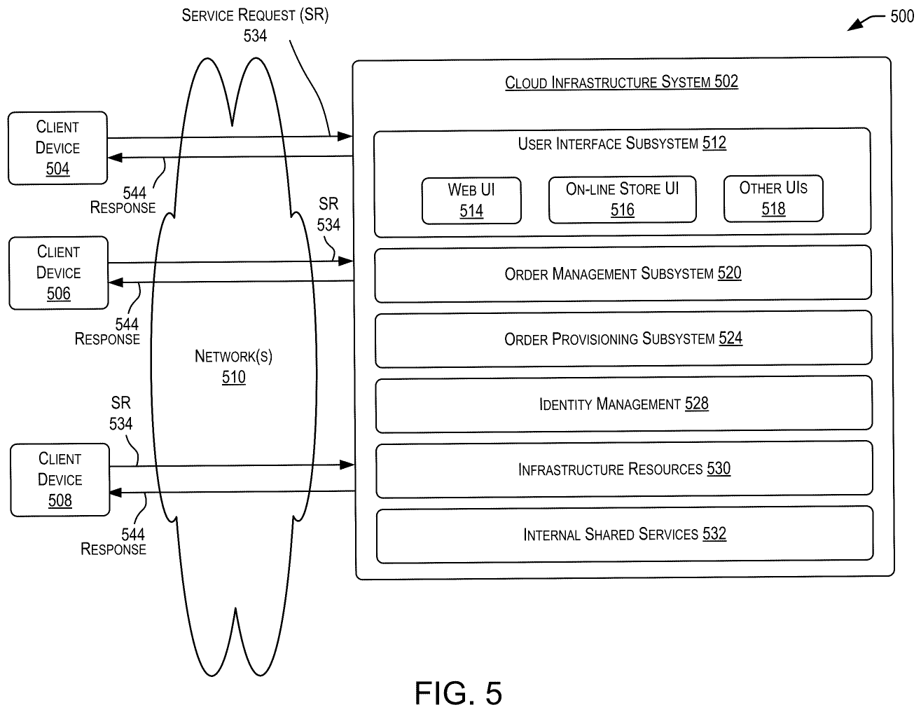

FIG. 5 is a simplified block diagram of a cloud-based system environment in which provides a context-specific prompt to answer a user query, in accordance with certain aspects. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 414. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may be searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to. For example, a tenant may place a subscription order for a chatbot related service offered by cloud infrastructure system 502. As part of the order, the client may provide information identifying the input (e.g. utterances).

In certain aspects, such as the embodiment depicted in FIG. 5, cloud infrastructure system 502 may comprise an order management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the order provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

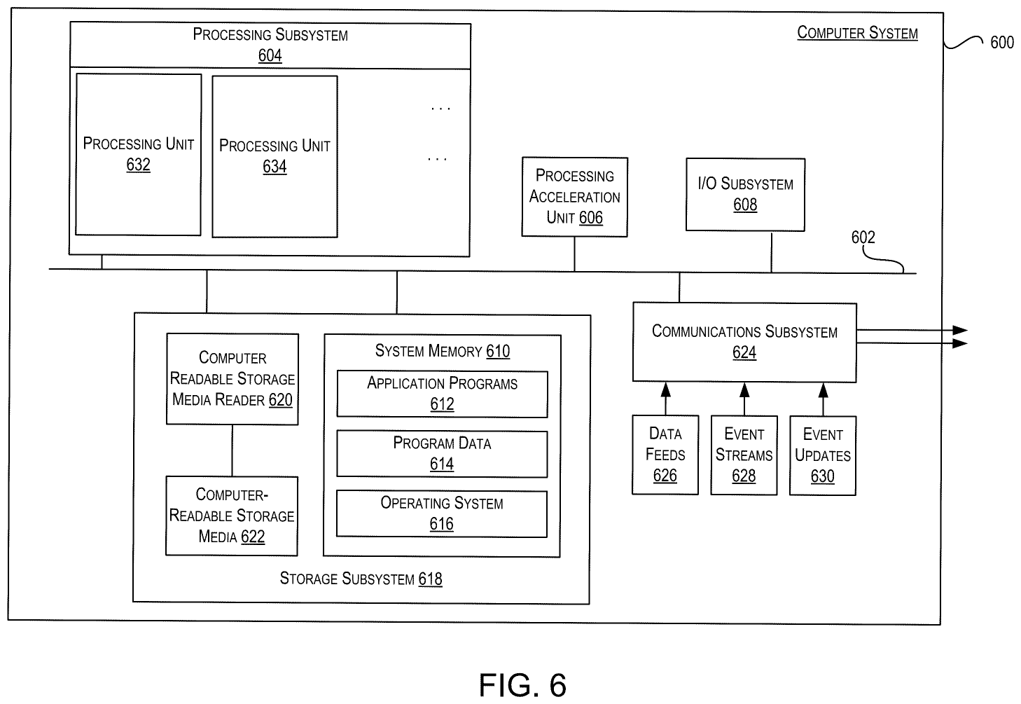

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, the communications subsystem may be used to transmit a response to a user regarding the inquiry for a chatbot.

Communications subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communications subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
determining that a particular user is authenticated to an application session, and determining a particular role of the particular user;
accessing a natural language request from the particular user;
selecting, from a plurality of fields available, a subset of fields that are associated with the particular role and that are determined to be relevant to the natural language request;
generating a prompt that identifies the subset of fields, and requests a command executable to answer the natural language request;
prompting a large language model to generate a resulting command;
causing execution of an executable command based at least in part on the resulting command, wherein the executable command causes data to be retrieved to generate a result set;
causing display of a response to the natural language request based at least in part on the result set.

2. The computer-implemented method of claim 1, wherein generating the prompt comprises determining, for inclusion in the prompt, domain-specific content relevant to the natural language request, wherein the determining is based at least in part on a particular vector embedding of the natural language request, one or more vector embeddings of the domain-specific content, and one or more distances between the particular vector embedding and the one or more vector embeddings.

3. The computer-implemented method of claim 1, wherein generating the prompt comprises determining, for inclusion in the prompt, one or more example pairings of LLM input and output relevant to the natural language request, wherein the determining is based at least in part on a particular vector embedding of the natural language request, one or more vector embeddings of the one or more example pairings, and one or more distances between the particular vector embedding and the one or more vector embeddings.

4. The computer-implemented method of claim 1, wherein selecting the subset of fields that are associated with the particular role and that are determined to be relevant to the natural language request comprises selecting, for inclusion in the prompt, one or more fields relevant to the natural language request based at least in part on a particular vector embedding of the natural language request, one or more vector embeddings of the one or more fields, and one or more distances between the particular vector embedding and the one or more vector embeddings.

5. The computer-implemented method of claim 1, wherein generating the prompt comprises determining, for inclusion in the prompt, one or more values of contextual information from a user session in which the natural language request was submitted.

6. The computer-implemented method of claim 1, wherein generating the prompt comprises determining a particular level of aggregation to recommend for the particular user based at least in part on the particular role; wherein the prompt requests a command executable to answer the natural language request at least in part by applying the particular level of aggregation.

7. The computer-implemented method of claim 1, wherein accessing, selecting, generating, and prompting are performed by a plurality of different agents supporting the natural language request, further comprising:
receiving a plurality of partial results from the plurality of different agents; and
assembling the plurality of results to determine the response to the natural language request.

8. The computer-implemented method of claim 1, wherein generating the prompt identifies one or more commands of an application programming interface, and wherein causing execution of the executable command based at least in part on the resulting command comprises invoking the application programming interface with the executable command.

9. The computer-implemented method of claim 1, wherein generating the prompt identifies one or more workflows, one or more functional descriptions of the one or more workflows, and one or more triggers of the one or more workflows that are based on values of one or more fields, and wherein causing execution of the executable command based at least in part on the resulting command comprises updating data of the one or more fields to satisfy the one or more triggers of the one or more workflows.

10. The computer-implemented method of claim 1, wherein the subset of fields comprises one or more first fields that are frequently used by users having the particular role and one or more second fields that are infrequently used by users having the particular role, and wherein generating the prompt identifies the one or more first fields as frequently used and the one or more second fields as infrequently used.

11. A computer-program product comprising one or more non-transitory machine-readable storage media, including stored instructions configured to cause a computing system to perform a set of actions including:
determining that a particular user is authenticated to an application session, and determining a particular role of the particular user;
accessing a natural language request from the particular user;
selecting, from a plurality of fields available, a subset of fields that are associated with the particular role and that are determined to be relevant to the natural language request;
generating a prompt that identifies the subset of fields, and requests a command executable to answer the natural language request;
prompting a large language model to generate a resulting command;
causing execution of an executable command based at least in part on the resulting command, wherein the executable command causes data to be retrieved to generate a result set;
causing display of a response to the natural language request based at least in part on the result set.

12. The computer-program product of claim 11, wherein the set of actions include the action of generating the prompt at least in part by determining, for inclusion in the prompt, domain-specific content relevant to the natural language request, wherein the determining is based at least in part on a particular vector embedding of the natural language request, one or more vector embeddings of the domain-specific content, and one or more distances between the particular vector embedding and the one or more vector embeddings.

13. The computer-program product of claim 11, wherein the set of actions include the action of generating the prompt at least in part by determining, for inclusion in the prompt, one or more example pairings of LLM input and output relevant to the natural language request, wherein the determining is based at least in part on a particular vector embedding of the natural language request, one or more vector embeddings of the one or more example pairings, and one or more distances between the particular vector embedding and the one or more vector embeddings.

14. The computer-program product of claim 11, wherein the set of actions include the action of the selecting the subset of fields that are associated with the particular role and that are determined to be relevant to the natural language request at least in part by selecting, for inclusion in the prompt, one or more fields relevant to the natural language request based at least in part on a particular vector embedding of the natural language request, one or more vector embeddings of the one or more fields, and one or more distances between the particular vector embedding and the one or more vector embeddings.

15. The computer-program product of claim 11, wherein the set of actions include the action of generating the prompt at least in part by determining, for inclusion in the prompt, one or more values of contextual information from a user session in which the natural language request was submitted.

16. A system comprising:
one or more processors;
one or more non-transitory computer-readable media storing instructions, which, when executed by the system, cause the system to perform a set of actions including:
determining that a particular user is authenticated to an application session, and determining a particular role of the particular user;
accessing a natural language request from the particular user;
selecting, from a plurality of fields available, a subset of fields that are associated with the particular role and that are determined to be relevant to the natural language request;
generating a prompt that identifies the subset of fields, and requests a command executable to answer the natural language request;
prompting a large language model to generate a resulting command;
causing execution of an executable command based at least in part on the resulting command, wherein the executable command causes data to be retrieved to generate a result set;
causing display of a response to the natural language request based at least in part on the result set.

17. The system of claim 16, wherein the set of actions include the action of generating the prompt at least in part by determining, for inclusion in the prompt, domain-specific content relevant to the natural language request, wherein the determining is based at least in part on a particular vector embedding of the natural language request, one or more vector embeddings of the domain-specific content, and one or more distances between the particular vector embedding and the one or more vector embeddings.

18. The system of claim 16, wherein the set of actions include the action of generating the prompt at least in part by determining, for inclusion in the prompt, one or more example pairings of LLM input and output relevant to the natural language request, wherein the determining is based at least in part on a particular vector embedding of the natural language request, one or more vector embeddings of the one or more example pairings, and one or more distances between the particular vector embedding and the one or more vector embeddings.

19. The system of claim 16, wherein the set of actions include the action of the selecting the subset of fields that are associated with the particular role and that are determined to be relevant to the natural language request at least in part by selecting, for inclusion in the prompt, one or more fields relevant to the natural language request based at least in part on a particular vector embedding of the natural language request, one or more vector embeddings of the one or more fields, and one or more distances between the particular vector embedding and the one or more vector embeddings.

20. The system of claim 16, wherein the set of actions include the action of generating the prompt at least in part by determining, for inclusion in the prompt, one or more values of contextual information from a user session in which the natural language request was submitted.
